(19) United States
(12) Patent Application Publication
(10) Pub. No.: US 2022/0121797 A1
(43) Pub. Date: Apr. 21, 2022

(54) METHOD FOR ANALYZING GLOBAL STABILITY OF CONVEYING FLUID PIPE-NONLINEAR ENERGY SINK SYSTEM

(71) Applicant: DALIAN UNIVERSITY OF TECHNOLOGY, Dalian, Liaoning (CN)

(72) Inventors: Ximing SUN, Dalian, Liaoning (CN); Nan DUAN, Dalian, Liaoning (CN); Yuhu WU, Dalian, Liaoning (CN); Chongquan ZHONG, Dalian, Liaoning (CN)

(21) Appl. No.: 17/291,819

(22) PCT Filed: Jul. 13, 2020
(86) PCT No.: PCT/CN2020/101592

§ 371 Date: May 6, 2021

(51) Int. Cl. G06F 30/23; G06F 17/13

(52) U.S. Cl. CPC G06F 30/23; G06F 17/13

(57) ABSTRACT

The present invention provides a method for analyzing global stability of a conveying fluid pipe-nonlinear energy sink system, and belongs to the technical field of system stability proof and analysis of a control system. The method comprises: establishing a high-order partial differential model of a conveying fluid pipe-nonlinear energy sink system based on a target energy transfer theory, discretizing the model into a second-order nonlinear ordinary differential form by means of the Galerkin approximation method, and further transforming the model into a quadratic model containing gradient information first; then obtaining a global stability judgment condition of the system by means of the energy disturbance technology, and verifying the theoretical results by means of the numerical method finally.

### TECHNICAL FIELD

The present invention belongs to the technical field of system stability proof and analysis of a control system, and relates to an ordinary differentiation and energy disturbance technology of a high-order partial differential equation model, in particular to an exponential stability analysis method based on the Lyapunov stability theory.

### BACKGROUND

A conveying fluid pipe has an important application value and a wide application range in the industrial field, for example, in heat exchange, fuel oil transmission, hydraulic pressure and other fields, the pipe is used to convey fluid having a wide range of change in fluid velocity, wherein the change in fluid velocity may induce the pipe to generate excessive vibration, thereby causing a machine to generate faults such as noise, material fatigue, leakage, etc., so that the equipment cannot reach the required performance index. In the aspect of vibration control of the conveying fluid pipe, passive vibration controllers have attracted more and more attention due to the advantages of small installation space limitation, no need of energy input, good economy and high reliability, among which a passive vibration controller based on a nonlinear energy sink has been widely concerned and studied, and some control effects have been obtained. The introduction of the nonlinear energy sink as a strong nonlinear attachment will inevitably affect the stability of the system, but there is a lack of research on the stability of the conveying fluid pipe-nonlinear energy sink (NES) system. In the present invention, based on the understanding of a model of the conveying fluid pipe-NES system, an energy functional and a disturbance functional of the system are established using the convex characteristics and gradient characteristics of the system, a Lyapunov function of the system is established using the energy disturbance technology, the global exponential stability of the system is analyzed under the framework of the Lyapunov stability theory, and the results of theoretical proof are verified using the numerical method. So far, no patent has disclosed a global stability analysis method for a conveying fluid pipe-NES system based on the Lyapunov stability theory and energy disturbance technology.

### SUMMARY

In order to explain the influence of the introduction of the nonlinear energy sink on the system, there is a need to study the global stability of the conveying fluid pipe-NES system, and the present invention proposes a global stability analysis method for a conveying fluid pipe-NES system.

In the present invention, by means of the understanding and analysis of a model of the conveying fluid pipe-NES system, the original system model is transformed into a system model containing convex function gradient information, an energy functional and a disturbance functional of the system are carefully established based on this model, a Lyapunov function of the system is obtained using the energy disturbance technology, a judgment condition that the conveying fluid pipe-NES system is globally exponential stable is obtained under the framework of the Lyapunov stability theory, and the results of theoretical proof are verified using numerical simulation.

The technical solution of the present invention is as follows:

A method for analyzing global stability of a conveying fluid pipe-NES system, comprising the following steps:

Step 1: Modeling and Preprocessing of Conveying Fluid Pipe-NES System

The conveying fluid pipe is installed in a mode that both ends thereof are simply supported, and the nonlinear energy sink is connected with a conveying fluid pipe; moreover, without consideration of gravity, internal damping, external tension and pressurization effects, a mathematical model of the conveying fluid pipe-NES system may be written as follows:

$$EI \frac{{\partial }^{4} Y ( X , T )}{\partial {X}^{4}} + λ EI \frac{{\partial }^{5} Y ( X , T )}{\partial {X}^{4} \partial T} + {M}_{f} {V}^{2} \frac{{\partial }^{2} Y ( X , T )}{\partial {X}^{3}} + {M}_{f} V \frac{{\partial }^{2} Y ( X , T )}{\partial X \partial T} + ( {M}_{f} + {m}_{p} ) \frac{{\partial }^{2} Y ( X , T )}{\partial {T}^{2}} + \{ {K [ Y ( D , T ) - \overline{Y} ( T ) ]}^{3} + C [ \frac{\partial Y ( D , T )}{\partial T} - \frac{d \overline{Y} ( T )}{dT} ] \} δ ( X - D ) = 0 \\ {m}_{NES} \frac{{d}^{2} \overline{Y} ( T )}{{dT}^{2}} + {K [ \overline{Y} ( T ) - Y ( D , T ) ]}^{3} + C [ \frac{d \overline{Y} ( T )}{dT} - \frac{\partial Y ( D , T )}{\partial T} ] = 0 \qquad ( 1 )$$

where Y(X,T) represents a transverse displacement function of the conveying fluid pipe; EI represents a bending stiffness of the conveying fluid pipe; λ represents a viscoelastic coefficient of the conveying fluid pipe; M_{f} represents a mass of fluid in the conveying fluid pipe; mₚ represents a mass of the conveying fluid pipe itself; V represents a flow velocity of fluid in the conveying fluid pipe; T represents a time variable; Y̅(T) represents a displacement function of the NES; M_{NES} represents a structure mass of the NES; K represents a nonlinear (cubic nonlinear) stiffness of the NES; C represents damping of the NES; D represents an installation location of the NES; and δ(X−D) represents a Dirac δ function.

Step 2: Model Discretization

Since the original conveying fluid pipe-NES system model is in the form of a high-order partial differential equation (PDE), it is not convenient for subsequent global stability analysis, thus there is a need to transform same into the form of an ordinary differential equation (ODE) by means of the Galerkin approximate method. By means of the standard Galerkin, the conveying fluid pipe-NES system may be transformed into a finite dimensional dynamic system which is easier to manage; the specific process is as follows:

the standard Galerkin of the displacement of the conveying fluid pipe-NES system is:

$$y ( x , t ) = {\sum }_{r = 1}^{n} {ϕ}_{r} ( x ) {q}_{r} ( t ) \qquad ( 2 )$$

where ϕᵣ(x) represents the r^{th} eigenfunction when the conveying fluid pipe is in undamped free vibration; qᵣ(t) represents generalized coordinates of the discrete system; n represents the number of Galerkin discrete terms.

the higher-order PDE system model shown in equation (1) is transformed into a second-order nonlinear ODE form shown in equation (3) using the standard Galerkin shown in equation (2):

M\ddot{Z}+CŻ+KZ+FN(t)=0 (3)

where

$$Z = [ \frac{q}{y} ] ∈ {R}^{n + 1} , M = [ \begin{matrix}{M}_{0} & 0 \\ 0 & ɛ\end{matrix} ] , C = [ \begin{matrix}{C}_{0} + \tilde{C} & {\overline{C}}^{T} \\ \overline{C} & σ\end{matrix} ] , K = [ \begin{matrix}{K}_{0} & 0 \\ 0 & 0\end{matrix} ] F = [ \begin{matrix}- k {ϕ}_{rd} \\ k\end{matrix} ] , N ( t ) = {( \overline{y} - {ϕ}_{rd}^{T} q )}^{3} , {M}_{0} = {δ}_{r} , {C}_{0} = {αλ}_{r}^{4} {δ}_{r} + 2 \sqrt{β} υ {b}_{r} {K}_{0} = {λ}_{r}^{4} {δ}_{r} + {υ}^{2} {c}_{r} , \tilde{C} = {σϕ}_{rd} {ϕ}_{rd}^{T} , \overline{C} = - {ϕ}_{rd}^{T} \qquad ( 4 )$$

in equation (4), [symbol] represents a displacement of the NES, Rⁿ⁺¹, represents a n+1 dimensional space, ε represents a ratio of the structure mass of the NES to the sum of the mass of the pipe itself and the mass of fluid in the pipe, σ represents dimensionless damping of the NES, k represents a dimensionless stiffness of the NES, t represents a dimensionless time variable, α represents a dimensionless viscoelastic coefficient of the conveying fluid pipe itself, β represents a ratio of the mass of fluid in the pipe to the sum of the mass of the pipe itself and the mass of fluid in the pipe, and v represents a dimensionless flow velocity of the fluid in the pipe; λᵣ=rπ, r=1, . . . , n; ϕᵣ and ϕ_{rd} represent vectors composed of eigenfunctions in equation (2); q represents a vector composed of generalized coordinates in equation (2); δᵣ, bᵣ and cᵣ are Kronecker products of ϕᵣ and ϕᵣ, ϕᵣ and ϕᵣ′, and ϕᵣ and ϕᵣ″ respectively, specifically:

$$\begin{matrix}{ϕ}_{r} = \begin{matrix}{[ {ϕ}_{1} ( x ) … {ϕ}_{n} ( x ) ]}^{T} , & {ϕ}_{rd} = {[ {ϕ}_{r} ( d ) … {ϕ}_{n} ( d ) ]}^{T} , & q = {[ {q}_{1} ( t ) … {ϕ}_{n} ( t ) ]}^{T}\end{matrix} \\ {δ}_{r} = {\int }_{0}^{1} {ϕ}_{r} {ϕ}_{r}^{T} dx = [ \begin{matrix}{\int }_{0}^{1} {ϕ}_{1} ( x ) {ϕ}_{1} ( x ) dx & … & {\int }_{0}^{1} {ϕ}_{1} ( x ) {ϕ}_{n} ( x ) dx \\ ⋮ & ⋱ & ⋮ \\ {\int }_{0}^{1} {ϕ}_{n} ( x ) {ϕ}_{1} ( x ) dx & … & {\int }_{0}^{1} {ϕ}_{n} ( x ) {ϕ}_{n} ( x ) dx\end{matrix} ] = \frac{1}{2} I \\ {b}_{r} = {\int }_{0}^{1} {ϕ}_{r} {{ϕ}_{r}^{′}}^{T} dx = [ \begin{matrix}{\int }_{0}^{1} {ϕ}_{1} ( x ) {ϕ}_{1}^{′} ( x ) dx & … & {\int }_{0}^{1} {ϕ}_{1} ( x ) {ϕ}_{n}^{′} ( x ) dx \\ ⋮ & ⋱ & ⋮ \\ {\int }_{0}^{1} {ϕ}_{n} ( x ) {ϕ}_{1}^{′} ( x ) dx & … & {\int }_{0}^{1} {ϕ}_{n} ( x ) {ϕ}_{n}^{′} ( x ) dx\end{matrix} ] \\ {c}_{r} = {\int }_{0}^{1} {ϕ}_{r} {ϕ}_{r}^{″} dx = [ \begin{matrix}{\int }_{0}^{1} {ϕ}_{1} ( x ) {ϕ}_{1}^{″} ( x ) dx & … & {\int }_{0}^{1} {ϕ}_{1} ( x ) {ϕ}_{n}^{″} ( x ) dx \\ ⋮ & ⋱ & ⋮ \\ {\int }_{0}^{1} {ϕ}_{n} ( x ) {ϕ}_{1}^{″} ( x ) dx & … & {\int }_{0}^{1} {ϕ}_{n} ( x ) {ϕ}_{n}^{″} ( x ) dx\end{matrix} ] = - \frac{{π}^{2}}{2} diag ( {1}^{2} , … , {r}^{2} )\end{matrix} \qquad ( 5 )$$

Step 3: Quadratic Form Change of Model

based on the characteristics of the model of the conveying fluid pipe-NES system shown in equation (3), a potential function Φ(Z) of the conveying fluid pipe-NES system is established as follows:

$$Φ ( Z ) = \frac{1}{2} 〈 KZ , Z 〉 + \frac{k}{4} {( {{ϕ}_{rd}}^{T} q - \overline{y} )}^{4} \qquad ( 6 )$$

where [symbol] KZ, Z [symbol] represents an Euclidean inner product of vectors KZ and Z; according to equation (6), it is easy to obtain that Φ(Z) is a convex function, and the system model shown in equation (3) may be written as follows:

M\ddot{Z}+CŻ+∇Φ(Z)=0 (7)

where ∇Φ(Z) represents a gradient of the convex function Φ(Z).

Step 4: Global Stability Analysis

based on equation (7), an energy functional E(t) and a disturbance functional W(t) of the system model shown equation (3) are defined as follows:

$$\begin{matrix}E ( t ) = \frac{1}{2} 〈 M \dot{Z} , \dot{Z} 〉 + Φ ( Z ) & ( 8 ) \\ W ( t ) = 〈 M \dot{Z} , Z 〉 + \frac{1}{2} 〈 CZ , Z 〉 & ( 9 )\end{matrix}$$

based on the defined energy functional and disturbance functional, a Lyapunov function is defined as follows:

$${V}_{L} ( t ) = E ( t ) + \frac{1}{G} W ( t ) \qquad ( 10 )$$

where G represents a coefficient of influence of the disturbance functional on the Lyapunov function, and

$$G > max \{ \frac{{m}_{1}}{{λ}_{0}} , \frac{3}{2} {λ}_{{MC}^{- 1}}^{max} \} ,$$

m₁ represents a maximum eigenvalue of a matrix M, λ₀ represents a minimum eigenvalue of a matrix C, and λ_{MC}_{^{−1}}^{max} represents a maximum eigenvalue of the product of the matrix M and an inverse matrix of the matrix C.

Further, by means of functional analysis, it is obtained that the Lyapunov function V_{L}(t) satisfies the following exponential stability judgment condition:

$$0 ⩽ ( 1 - \frac{1}{G} \frac{{m}_{1}}{{λ}_{0}} ) E ( t ) ⩽ {V}_{L} ( t ) ⩽ {a}_{0} {e}^{- \frac{s}{P} t} \qquad ( 11 )$$

where a₀=V_{L}(0).

In consideration of

$$G > max \{ \frac{{m}_{1}}{{λ}_{0}} , \frac{3}{2} {λ}_{{MC}^{- 1}}^{max} \} , 0 < 1 - \frac{1}{G} \frac{{m}_{1}}{{λ}_{0}} < 1 ,$$

in combination with equation (11), it is obtained that the energy functional E(t) satisfies the following relation:

$$0 ⩽ E ( t ) ⩽ {b}_{0} {e}^{- \frac{s}{P} t} \qquad ( 14 )$$

where

$${b}_{0} = \frac{{a}_{0}}{1 - \frac{1}{G} \frac{{m}_{1}}{{λ}_{0}}} ;$$

thus, an exponential stability judgment condition of E(t) is obtained;

in combination with inequality (14) and equations (5) and (4), it is obtained that the global stability of the conveying fluid pipe-NES system shown in equation (3) is exponential stability.

The present invention has the following advantageous effects:

1) based on the Galerkin method, in the present invention, a quadratic model containing gradient information about a convex function of a conveying fluid pipe-NES system is first established, wherein the convex function is first proposed and proved on the basis of system characteristics;

2) based on the quadratic model, the conveying fluid pipe-NES system is analyzed and proved to be exponentially stable, and a strict analysis process is given; and

3) in the present invention, the effectiveness of the NES on pipe vibration control is more fully demonstrated from the point of view of stability and is no longer only limited to the general comparison of responses at pipe sections.

### DESCRIPTION OF DRAWINGS

FIG. 1 is a structural diagram of a conveying fluid pipe-NES system.

FIG. 2 shows energy function, Lyapunov function and corresponding exponential function of the conveying fluid pipe-NES system at different flow velocities; dimensionless fluid flow velocities in the conveying fluid pipe corresponding to (a)-(c) in sequence are 1.0, 2.0, 3.0, where the parameters of the conveying fluid pipe-NES system are α=0.001, β=0.8, ε=0.1, σ=0.1, k=8000, d=0.5, X=0.3.

FIG. 3 shows the comparison results of responses at several sections (i.e. X is 0.2, 0.5 and 0.8 respectively) of the conveying fluid pipe when there is no control and the nonlinear energy sink is used as a controller at different flow velocities, dimensionless fluid flow velocities v in the conveying fluid pipe corresponding to (a) to (c) in sequence are 1.0, 2.0, 3.0, where the dotted line in FIG. 3 represents the response of the conveying fluid pipe when there is no control; the full line represents the displacement response of the conveying fluid pipe when the NES is used as a controller, the parameters of the vibration controller are set as follows: α=0.001, β=0.8, ε=0.1, σ=0.1, k=8000, X=0.3.

### DETAILED DESCRIPTION

Detailed description of the present invention is described below in detail in combination with accompanying drawings and the proof derivation process of global stability.

The specific process of this embodiment is conducted in view of the stability analysis and simulation verification process of the conveying fluid pipe-NES system shown in FIG. 1, the detailed design steps are as follows:

At step 1: a mathematical model of conveying fluid pipe-nonlinear energy sink is established, a physical structure thereof is shown in FIG. 1. The length of the conveying fluid pipe of which the two ends are simply supported is L, the bending stiffness of the conveying fluid pipe is EI, the mass is mₚ, and the viscoelastic coefficient is λ. The nonlinear energy sink as a vibration controller is installed in a location D away from the left endpoint of the conveying fluid pipe, the nonlinear energy sink is used to absorb energy of vibration generated when fluid enters the pipe, and the structure thereof is composed of a damper, a nonlinear spring and a mass block. Without consideration of gravity, internal damping, external tension and pressurization effects, a motion equation of the conveying fluid pipe-nonlinear energy sink is as follows:

$$EI \frac{{\partial }^{4} Y ( X , T )}{\partial {X}^{4}} + λ EI \frac{{\partial }^{5} Y ( X , T )}{\partial {X}^{4} \partial T} + {M}_{f} {V}^{2} \frac{{\partial }^{2} Y ( X , T )}{\partial {X}^{3}} + {M}_{f} V \frac{{\partial }^{2} Y ( X , T )}{\partial X \partial T} + ( {M}_{f} + {m}_{p} ) \frac{{\partial }^{2} Y ( X , T )}{\partial {T}^{2}} + \{ {K [ Y ( D , T ) - \overline{Y} ( T ) ]}^{3} + C [ \frac{\partial Y ( D , T )}{\partial T} - \frac{d \overline{Y} ( T )}{dT} ] \} δ ( X - D ) = 0 {m}_{NES} \frac{{d}^{2} \overline{Y} ( T )}{{dT}^{2}} + {K [ \overline{Y} ( T ) - Y ( D , T ) ]}^{3} + C [ \frac{d \overline{Y} ( T )}{dT} - \frac{\partial Y ( D , T )}{\partial T} ] = 0 \qquad ( 1 )$$

where Y(X,T) represents a longitudinal displacement of the conveying fluid pipe, accordingly, Y̅(T) represents a longitudinal displacement of the nonlinear energy sink, M_{f} represents a mass of fluid in the conveying fluid pipe, and m_{NES} represents a structure mass of the NES; V represents a flow velocity of fluid in the pipe; D represents an installation location parallel to the NES system; K represents a nonlinear (cubic nonlinear) stiffness of the NES; and C represents damping of the nonlinear energy sink.

In the first equation of equation set (1), the first term represents a flexural restoring force; the second term represents viscoelasticity of the conveying fluid pipe; the third term represents a centrifugal force generated by fluid flow; the fourth term represents a Coriolis effect; the fifth term represents an inertia force of the pipe and fluid when the pipe is filled with fluid; and the remaining two terms represent coupling between the conveying fluid pipe and the vibration controller.

It should be noted that the nonlinear energy sink is a system with light mass as compared in mass to the conveying fluid pipe system filled with fluid, as shown below:

$$\frac{{m}_{NES}}{{M}_{f} + {m}_{p}} = ɛ ⪡ 1 \qquad ( 2 )$$

wherein ε represents a parameter far less than 1.

In order to make the global stability analysis and following numerical verification of the conveying fluid pipe-NES system more general, there is a need to transform the system shown in equation (1) into the dimensionless form, and the dimensionless process is as follows:

$$y = \frac{Y}{L} , x = \frac{X}{L} , \overline{y} = \frac{\overline{Y}}{L} , d = \frac{D}{L} , k = \frac{{KL}^{6}}{EI} , υ = VL \sqrt{\frac{{M}_{f}}{EI}} , t = \frac{T}{{L}^{2}} \sqrt{\frac{EI}{{M}_{f} + {m}_{p}}} \\ α = \frac{λ}{{L}^{2}} \sqrt{\frac{EI}{{M}_{f} + {m}_{p}}} , β = \frac{{M}_{f}}{{M}_{f} + {m}_{p}} , ɛ = \frac{{m}_{NES}}{{M}_{f} + {m}_{p}} , σ = \frac{{CL}^{2}}{\sqrt{EI ( {M}_{f} + {m}_{p} )}} \qquad ( 3 )$$

in equation (3), L represents a length of the conveying fluid pipe, x represents a dimensionless form of a length independent variable X of the conveying fluid pipe, [symbol] represents a dimensionless form of a longitudinal displacement Y(X,T) of the conveying fluid pipe, y̅ represents a dimensionless form of a longitudinal displacement Y̅(T) of the nonlinear energy sink, d represents an installation location of the dimensionless nonlinear energy sink, k represents a dimensionless nonlinear stiffness of the nonlinear energy sink, v represents a dimensionless flow velocity of fluid in the conveying fluid pipe, t represents a dimensionless time variable, α represents a dimensionless viscoelastic coefficient of the conveying fluid pipe, β represents a ratio of the mass of fluid in the conveying fluid pipe to the sum of the mass of the conveying fluid pipe and the mass of the fluid, and σ represents dimensionless damping of the nonlinear energy sink.

Equation (3) is substituted into equation set (1), obtaining a dimensionless form of equation set (1):

$$\frac{{\partial }^{4} y ( x , t )}{\partial {x}^{4}} + α \frac{{\partial }^{5} y ( x , t )}{\partial {x}^{4} \partial t} + {υ}^{2} \frac{{\partial }^{2} y ( x , t )}{\partial {x}^{2}} + 2 \sqrt{β} υ \frac{{\partial }^{2} y ( x , t )}{\partial x \partial t} + \frac{{\partial }^{2} y ( x , t )}{\partial {t}^{2}} + {\{ k [ y ( d , t ) - \overline{y} ( t ) \} ]}^{3} + σ [ \frac{\partial y ( d , t )}{\partial t} - \frac{d \overline{y} ( t )}{dt} ] \} δ ( x - d ) = 0 ɛ \frac{{d}^{2} \overline{y} ( t )}{{dt}^{2}} + {k [ \overline{y} ( t ) - y ( d , t ) ]}^{3} + σ [ \frac{d \overline{y} ( t )}{dt} - \frac{\partial y ( d , t )}{\partial t} ] = 0 \qquad ( 4 )$$

Step 2: by means of the standard Galerkin, the high-order PDE model of the conveying fluid pipe-vibration controller system shown in equation (4) is approximately transformed into a finite dimensional dynamic system which is easier to manage. Therefore, the displacement of the system may be expanded into the following form:

$$y ( x , t ) = {\sum }_{r = 1}^{n} {ϕ}_{r} ( x ) {q}_{r} ( t ) \qquad ( 5 )$$

where ϕ^{r}(x) represents an eigenfunction when the conveying fluid pipe is in undamped free vibration, qᵣ(t) represents generalized coordinates of the discrete system, and n represents the number of Galerkin discrete terms. Considering that the conveying fluid pipe tube is of a structure simply supported at the two ends, the eigenfunction is selected as follows:

ϕ^{r}(x)=sin(λᵣx),λᵣ=rπ,r=1, . . . ,n (6)

that is, ϕ^{r}″″(x)=λᵣ⁴ϕᵣ(x).

Equation (5) is substituted into equation set (4), obtaining an equation set of the following form:

$${\sum }_{r = 1}^{n} [ {λ}_{r}^{4} {ϕ}_{r} ( x ) {q}_{r} ( t ) + α {λ}_{r}^{4} {ϕ}_{r} ( x ) {\dot{q}}_{r} ( t ) + {v}^{2} {ϕ}_{r}^{″} ( x ) {q}_{r} ( t ) + 2 \sqrt{β} v {ϕ}_{r}^{′} ( x ) {\dot{q}}_{r} ( t ) + {ϕ}_{r} ( x ) {\ddot{q}}_{r} ( t ) ] + \{ {k [ {\sum }_{r = 1}^{n} {ϕ}_{r} ( d ) {q}_{r} ( t ) - \overline{y} ( t ) ]}^{3} + σ [ {\sum }_{r = 1}^{n} {ϕ}_{r} ( d ) {\dot{q}}_{r} ( t ) - \dot{\overline{y}} ( t ) ] \} δ ( x - d ) = 0 \\ ɛ \ddot{\overline{y}} ( t ) + {k [ \overline{y} ( t ) - {\sum }_{r = 1}^{n} {ϕ}_{r} ( d ) {q}_{r} ( t ) ]}^{3} + σ [ \dot{\overline{y}} ( t ) - {\sum }_{r = 1}^{n} {ϕ}_{r} ( d ) {\dot{q}}_{r} ( t ) ] = 0 \qquad ( 7 )$$

To simplify and facilitate subsequent derivation processes, the following vectors are defined:

ϕᵣ=[ϕ₁(x) . . . ϕₙ(x)]^{T},ϕ_{rd}=[ϕ₁(d) . . . ϕₙ(d)]^{T}q=[q₁(t) . . . qₙ(t)]^{T} (8)

Equation set (7) may be written into the following vector form:

$${λ}_{r}^{4} {ϕ}_{r}^{T} q + {αλ}_{r}^{4} {ϕ}_{r}^{T} \dot{q} + {v}^{2} {ϕ}_{r}^{″ T} q + 2 \sqrt{β} v {ϕ}_{r}^{′ T} \dot{q} + {ϕ}_{r}^{T} \ddot{q} + [ {k ( {ϕ}_{r d}^{T} q - \overline{y} )}^{3} + σ ( {ϕ}_{r d} \dot{q} - \dot{\overline{y}} ) ] δ ( x - d ) = 0 \\ ɛ \ddot{\overline{y}} + {k ( \overline{y} - {ϕ}_{r d}^{T} q )}^{3} + σ ( \dot{\overline{y}} - {ϕ}_{r d}^{T} \dot{q} ) = 0 \qquad ( 9 )$$

The similar terms in equation set (9) are united, obtaining the following form:

$${ϕ}_{r}^{T} \ddot{q} + [ α {λ}_{r}^{4} {ϕ}_{r}^{T} + 2 \sqrt{β} v {ϕ}_{r}^{′ T} ] \dot{q} + [ {λ}_{r}^{4} {ϕ}_{r}^{T} + {v}^{2} {ϕ}_{r}^{″ T} ] q + [ {k ( {ϕ}_{r d}^{T} q - \overline{y} )}^{3} + σ ( {ϕ}_{r d}^{T} \dot{q} - \dot{\overline{y}} ) ] δ ( x - d ) = 0 \\ ɛ \ddot{\overline{y}} + σ ( {ϕ}_{r d}^{T} \dot{q} - \dot{\overline{y}} ) + {k ( {ϕ}_{r d}^{T} q - \overline{y} )}^{3} = 0 \qquad ( 10 )$$

The first equation in equation set (10) is multiplied by ϕᵣ and integrated within [0, 1], obtaining the following equation:

$${δ}_{r} \ddot{q} + [ α {λ}_{r}^{4} {δ}_{r} + 2 \sqrt{β} v {b}_{r} ] \dot{q} + [ {λ}_{r}^{4} {δ}_{r} + {v}^{2} {c}_{r} ] q + [ {k ( {ϕ}_{r d}^{T} q - \overline{y} )}^{3} + σ ( {ϕ}_{r d}^{T} \dot{q} - \dot{\overline{y}} ) ] {ϕ}_{r d} = 0 \\ ɛ \ddot{\overline{y}} + σ \dot{\overline{y}} - σ {ϕ}_{r d}^{T} \dot{q} + {k ( \overline{y} - {ϕ}_{r d}^{T} q )}^{3} = 0 \qquad ( 11 )$$

where δᵣ, bᵣ and cᵣ represent Kronecker products of ϕᵣ and ϕᵣ, ϕᵣ and ϕᵣ′ and ϕᵣ and ϕᵣ″ respectively, specifically:

$${δ}_{r} = {\int }_{0}^{1} {ϕ}_{r} {ϕ}_{r}^{T} dx = [ \begin{matrix}{\int }_{0}^{1} {ϕ}_{1} ( x ) {ϕ}_{1} ( x ) dx & … & {\int }_{0}^{1} {ϕ}_{1} ( x ) {ϕ}_{n} ( x ) dx \\ ⋮ & ⋱ & ⋮ \\ {\int }_{0}^{1} {ϕ}_{n} ( x ) {ϕ}_{1} ( x ) dx & … & {\int }_{0}^{1} {ϕ}_{n} ( x ) {ϕ}_{n} ( x ) dx\end{matrix} ] = \frac{1}{2} I \\ {b}_{r} = {\int }_{0}^{1} {ϕ}_{r} {ϕ}_{r}^{′ T} dx = [ \begin{matrix}{\int }_{0}^{1} {ϕ}_{1} ( x ) {ϕ}_{1}^{′} ( x ) dx & … & {\int }_{0}^{1} {ϕ}_{1} ( x ) {ϕ}_{n}^{′} ( x ) dx \\ ⋮ & ⋱ & ⋮ \\ {\int }_{0}^{1} {ϕ}_{n} ( x ) {ϕ}_{1}^{′} ( x ) dx & … & {\int }_{0}^{1} {ϕ}_{n} ( x ) {ϕ}_{n}^{′} ( x ) dx\end{matrix} ] \\ {c}_{r} = {\int }_{0}^{1} {ϕ}_{r} {ϕ}_{r}^{″ T} dx = [ \begin{matrix}{\int }_{0}^{1} {ϕ}_{1} ( x ) {ϕ}_{1}^{″} ( x ) dx & … & {\int }_{0}^{1} {ϕ}_{1} ( x ) {ϕ}_{n}^{″} ( x ) dx \\ ⋮ & ⋱ & ⋮ \\ {\int }_{0}^{1} {ϕ}_{n} ( x ) {ϕ}_{1}^{″} ( x ) dx & … & {\int }_{0}^{1} {ϕ}_{n} ( x ) {ϕ}_{n}^{″} ( x ) dx\end{matrix} ] = - \frac{{π}^{2}}{2} diag ( {1}^{2} , … , {r}^{2} ) \qquad ( 12 )$$

I represents a unit matrix, and based on equation (6), the specific form of the Kronecker product δᵣ may be deduced as:

$${\int }_{0}^{1} {ϕ}_{r} ( x ) {ϕ}_{r} ( x ) dx = {\int }_{0}^{1} sin ( i π x ) sin ( j π x ) dx = \{ \begin{matrix}0 , & i \neq j \\ \frac{1}{2} , & i = j\end{matrix}$$

thus obtaining δᵣ=½I. Similarly, the specific form of the Kronecker product bᵣ may be deduced as:

$${\int }_{0}^{1} {ϕ}_{r} ( x ) {ϕ}_{r}^{′} ( x ) dx = {\int }_{0}^{1} sin ( i π x ) {sin}^{′} ( j π x ) dx = \{ \begin{matrix}\frac{2 ij}{{i}^{2} - {j}^{2}} , & i + j = 2 μ - 1 \\ 0 , & i + j = 2 μ\end{matrix}$$

where μ∈(1, 2, . . . , r), thus obtaining an anti-symmetric matrix. Similarly, it can be obtained that the Kronecker product cᵣ is a diagonal matrix in the form of

$${c}_{r} = - \frac{{π}^{2}}{2} diag ( {1}^{2} , {2}^{2} , … , {r}^{2} ) .$$

Equation set (11) may be further combined into a vector product form.

$${δ}_{r} \ddot{q} + [ α {λ}_{r}^{4} {δ}_{r} + 2 \sqrt{β} v {b}_{r} + σ {ϕ}_{r d} {ϕ}_{r d}^{T} - σ {ϕ}_{r d} ] [ \begin{matrix}\dot{q} \\ \dot{\overline{y}}\end{matrix} ] + [ {λ}_{r}^{4} {δ}_{r} + {v}^{2} {c}_{r} ] q - k {{ϕ}_{r d} ( \overline{y} - {ϕ}_{r d}^{T} q )}^{3} = 0 \\ ɛ \ddot{\overline{y}} ( t ) + [ - σ {ϕ}_{r d}^{T} σ ] [ \begin{matrix}\dot{q} \\ \dot{\overline{y}}\end{matrix} ] + {k ( \overline{y} - {ϕ}_{r d}^{T} q )}^{3} = 0 \qquad ( 13 )$$

So far, the fourth-order partial differential of the conveying fluid pipe—NES shown in equation (4) is transformed to the following second-order nonlinear ordinary differential form:

M\ddot{Z}+CŻ+KZ+FN(t)=0 (14)

where

$$Z = [ \begin{matrix}q \\ \overline{y}\end{matrix} ] ∈ {R}^{n + 1} , M = [ \begin{matrix}{M}_{0} & 0 \\ 0 & ɛ\end{matrix} ] , C = [ \begin{matrix}{C}_{0} + \tilde{C} & {\overline{C}}^{T} \\ \overline{C} & σ\end{matrix} ] , K = [ \begin{matrix}{K}_{0} & 0 \\ 0 & 0\end{matrix} ] \\ F = [ \begin{matrix}- k {σ}_{r d} \\ k\end{matrix} ] , N ( t ) = {( \overline{y} - {ϕ}_{r d}^{T} q )}^{3} , {M}_{0} = {δ}_{r} , {C}_{0} = α {λ}_{r}^{4} {δ}_{r} + 2 \sqrt{β} v {b}_{r} \\ {K}_{0} = {λ}_{r}^{4} {δ}_{r} + {v}^{2} {c}_{r} , \tilde{C} = σ {ϕ}_{r d} {ϕ}_{r d}^{T} , \overline{C} = - σ {ϕ}_{r d}^{T} \qquad ( 15 )$$

Step 3: Quadratic form change of model

A potential function Φ(Z) of the conveying fluid pipe-NES system is defined as follows:

$$Φ ( Z ) = \frac{1}{2} 〈 KZ , Z 〉 + \frac{k}{4} {( {ϕ}_{r d}^{T} q - \overline{y} )}^{4} \qquad ( 16 )$$

where [symbol] KZ, Z [symbol] represents an Euclidean inner product of vectors KZ and Z.

According to equation (16), it is easy to deduce that the gradient Φ(Z) of ∇Φ(Z) is as follows:

∇Φ(Z)=KZ+(ϕ_{rd}^{T}q− [symbol] )³[kϕ_{rd}−k]^{T} (17)

The Hessian matrix to (Z) of ∇²Φ(Z) is as follows:

$$\begin{matrix}{∇}^{2} Φ ( Z ) = K + {{( {ϕ}_{r d}^{T} q - \overline{q} )}^{2} [ k {ϕ}_{r d} - k ]}^{T} [ 3 {ϕ}_{r d}^{T} - 3 ] \\ = K + 3 {k ( {ϕ}_{r d}^{T} q - \overline{y} )}^{2} [ \begin{matrix}{ϕ}_{r d}^{T} {ϕ}_{r d} & - {ϕ}_{r d} \\ - {ϕ}_{r d}^{T} & 1\end{matrix} ]\end{matrix} \qquad ( 18 )$$

where k>0 represents a dimensionless stiffness of the nonlinear energy sink. As shown in equation (15), K represents a positive semidefinite matrix; as shown in equation (6), ϕ^{r}(d)=sin(rπd), it is easy to obtain that all eigenvalues of the matrix

$$[ \begin{matrix}{ϕ}_{r d}^{T} {ϕ}_{r d} & - {ϕ}_{r d} \\ - {ϕ}_{r d}^{T} & 1\end{matrix} ]$$

in Equation (18) are greater than or equal to 0, that is,

$$[ \begin{matrix}{ϕ}_{r d}^{T} {ϕ}_{r d} & - {ϕ}_{r d} \\ - {ϕ}_{r d}^{T} & 1\end{matrix} ]$$

is also a positive semidefinite matrix. Therefore, the Hessian matrix ∇²⁰Φ(Z) is a positive semidefinite matrix, indicating that Φ(Z) is a convex function.

Then, based on the convex function Φ(Z) and gradient characteristics thereof, equation (14) may be further transformed into a form containing the gradient information of the convex function, that is,

M\ddot{Z}+CŻ+∇Φ(Z)=0 (19)

Step 4: global stability analysis

Based on equation (19), an energy functional E(t) and a disturbance functional W(t) of the conveying fluid pipe-NES system are defined as follows:

E(t)=½ [symbol] MŻ,Ż [symbol] +Φ(Z) (20)

W(t)= [symbol] MŻ,Z [symbol] +½ [symbol] CZ,Z [symbol] (21)

As shown in Equation (15), M is a positive definite matrix, and K is a positive semidefinite matrix. It should be noted that the matrix C is not completely symmetrical, and is formed by augmenting the matrixes C₀, \tilde{C} and C̅ and the constant σ, where \tilde{C} is a symmetric matrix. As shown in equation (15), C₀ is a linear combination of matrices δᵣ and bᵣ. Recalling equation (12), δᵣ is a diagonal matrix, and bᵣ is an anti-symmetric matrix. Since the quadratic form of the anti-symmetric matrix is 0, inequality [symbol] CŻ,Ż [symbol] ≥λ_{C}^{min}∥Ż∥₂² holds, which indicates that the matrix C may be considered as a symmetric matrix.

The disturbance functional W(t) shall then be processed as necessary. According to equation (21), the following relation is obtained:

W(t)≥ [symbol] MŻ,Z [symbol] +½λ₀∥Z∥₂² (22)

where λ₀ represents the minimum eigenvalue of the matrix C.

A Young inequality is applied:

$$〈 X , Y 〉 ⩾ - \frac{1}{2 θ} {‖ Z ‖}_{2}^{2} - \frac{θ}{2} {‖ Y ‖}_{2}^{2}$$

where θ=λ₀. Inequality (22) may be transformed into the following form:

$$W ( t ) ⩾ - \frac{1}{2 {λ}_{0}} {‖ M \dot{Z} ‖}_{2}^{2} - \frac{1}{2} {λ}_{0} {‖ Z ‖}_{2}^{2} + \frac{1}{2} {λ}_{0} {‖ Z ‖}_{2}^{2} = - \frac{1}{2 {λ}_{0}} {‖ M \dot{Z} ‖}_{2}^{2} ⩾ - \frac{{m}_{1}}{2 {λ}_{0}} 〈 M \dot{ Z} , \dot{Z} 〉 \qquad ( 23 )$$

where m₁ represents the maximum eigenvalue of the matrix M shown in equation (15), and thus the last term of equation (23) holds.

Based on the definitions of the convex function Φ(Z) and the energy functional E(t), it is easy to obtain Φ(Z)≥0, which means E(t)≥½ [symbol] MŻ,Ż [symbol] . In combination with inequality (23), it is easy to obtain:

$$W ( t ) ⩾ - \frac{{m}_{1}}{{λ}_{0}} E ( t ) \qquad ( 24 )$$

For the energy function of the system shown in equation (20), the following form may be deduced:

Ė(t)= [symbol] Ż,M\ddot{Z} [symbol] + [symbol] Ż,∇Φ(Z) [symbol] = [symbol] Ż,M\ddot{Z}+∇Φ(Z) [symbol] =− [symbol] Ż,CŻ [symbol] ≤−λ₀∥Ż∥₂² (25)

For the disturbance function of the system shown in (21), the derivative thereof may be obtained as follows:

$$\begin{matrix}\dot{W} ( t ) = 〈 M \ddot{Z} , Z 〉 + 〈 M \dot{Z} , \dot{Z} 〉 + \frac{1}{2} 〈 C Z , \dot{Z} 〉 + \frac{1}{2} 〈 C \dot{Z} , Z 〉 \\ = 〈 M \ddot{Z} , Z 〉 + 〈 M \dot{Z} , \dot{Z} 〉 + 〈 C \dot{Z} , Z 〉 \\ = 〈 M \ddot{Z} + C \dot{Z} , Z 〉 + 〈 M \dot{Z} , Z 〉\end{matrix} \qquad ( 26 )$$

Equation (19) is substituted into equation (26), obtaining

W(t)= [symbol] ∇Φ(Z),Z [symbol] + [symbol] MŻ,Ż [symbol] (27)

Considering that Φ(Z) is a convex function, for Z∈Rⁿ⁺¹, the following inequality is obtained:

[symbol]

∇Φ(Z),Z [symbol] Φ(Z) (28)

Therefore, in combination with equation (27) and inequality (28), the following inequality is obtained:

W(t)≤−Φ(Z)+ [symbol] MŻ,Z [symbol] (29)

Inequality (29) is added to equation (20), obtaining the following relation:

$$\begin{matrix}E ( t ) + W ( t ) ⩽ \frac{1}{2} 〈 M \dot{Z} , \dot{Z} 〉 + Φ ( Z ) - Φ ( Z ) + 〈 M \dot{Z} , \dot{Z} 〉 \\ = \frac{3}{2} 〈 M \dot{Z} , \dot{Z} 〉 = \frac{3}{2} {MC}^{- 1} 〈 C \dot{Z} , \dot{Z} 〉\end{matrix} \qquad ( 30 )$$

where C¹ is an inverse matrix of the matrix C. It is assumed that

$$G > \frac{3}{2} {λ}_{{MC}^{- 1}}^{max} ,$$

and inequality (24) is substituted into inequality (29), obtaining

E(t)+W(t)≤−GĖ(t) (31)

that is

E(t)+GĖ(t)+\dot{W}(t)≤0 (32)

for any θ>0, there is a Young inequality:

$$- \frac{1}{2 θ} {‖ X ‖}_{2}^{2} - \frac{θ}{2} {‖ Y ‖}_{2}^{2} ⩽ 〈 X , Y 〉 ⩽ - \frac{1}{2 θ} {‖ X ‖}_{2}^{2} + \frac{θ}{2} {‖ Y ‖}_{2}^{2} \qquad ( 33 )$$

Equation (21) satisfies the following inequality relation:

$$W ( t ) ⩽ \frac{{‖ M \dot{Z} ‖}_{2}^{2}}{2 θ} + \frac{θ}{2} {‖ Z ‖}_{2}^{2} + \frac{1}{2} {λ}_{C}^{max} {‖ Z ‖}_{2}^{2} \qquad ( 34 )$$

where λ_{C}^{max} represents the maximum eigenvalue of the matrix C. Considering the properties of the quadratic form, inequality (34) may be deduced into the following form:

$$\begin{matrix}W ( t ) ⩽ \frac{1}{2 θ} {‖ M ‖}_{2}^{2} {‖ \dot{Z} ‖}_{2}^{2} + \frac{1}{2} ( θ + {λ}_{C}^{max } ) {‖ Z ‖}_{2}^{2} \\ ⩽ \frac{1}{2 θ} {( {λ}_{M}^{max} )}^{2} {‖ \dot{Z} ‖}_{2}^{2} + \frac{1}{2} ( θ + {λ}_{C}^{max} ) {‖ Z ‖}_{2}^{2}\end{matrix} \qquad ( 35 )$$

where λ_{M}^{max} represents the maximum eigenvalue of the matrix M.

According to the definition of the convex function Φ(Z), it is easy to obtain that the last term of Φ(Z) is greater than or equal to 0, that is,

$$\frac{k}{4} {( {ϕ}_{r d}^{T} q - \overline{y} )}^{4} ⩾ 0 \qquad ( 36 )$$

Then, it is easy to obtain

Φ(Z)≥½λ_{K}^{min}∥Z∥₂² (37)

where λ_{K}^{min} represents the minimum eigenvalue of the stiffness matrix K of the system shown in equation (14). Therefore, the energy functional of the system satisfies the following inequality:

$$E ( t ) ⩾ \frac{1}{2} {λ}_{M}^{min} {‖ \dot{Z} ‖}_{2}^{2} + \frac{1}{2} {λ}_{K}^{min} {‖ Z ‖}_{2}^{2} \qquad ( 38 )$$

The inequality still holds after both sides thereof are multiplied by a positive real number P:

$$PE ( t ) ⩾ \frac{1}{2} P {λ}_{M}^{min} {‖ \dot{Z} ‖}_{2}^{2} + \frac{1}{2} P {λ}_{K}^{min} {‖ Z ‖}_{2}^{2} \qquad ( 39 )$$

the positive real number P can make the following inequalities hold

$$\frac{1}{2} P {λ}_{M}^{min} ⩾ \frac{1}{2 θ} {( {λ}_{M}^{max} )}^{2} \\ \frac{1}{2} P {λ}_{K}^{min} ⩾ \frac{θ}{2 } + \frac{1}{2} {λ}_{C}^{max} \qquad ( 40 )$$

In combination with inequalities (35), (39), (40), it is easy to obtain:

W(t)≤PE(t) (41)

the first term of inequality (32) may be further decomposed into the following form:

(1−s)E(t)+sE(t)+GĖ(t)+\dot{W}(t) (42)

where s∈[0, 1] Inequality (41) is substituted into inequality (42), obtaining

$$( 1 - s ) E ( t ) + \frac{s}{P} W ( t ) + G \dot{E} ( t ) + \dot{W} ( t ) ⩽ 0 \qquad ( 43 )$$

it may be further decomposed into the following form:

$$( 1 - s - \frac{Gs}{P} ) E ( t ) + \frac{Gs}{P} [ E ( t ) + \frac{1}{G} W ( t ) ] + G [ \dot{E} ( t ) + \frac{1}{G} \dot{W} ( t ) ] ⩽ 0 \qquad ( 44 )$$

If s is small enough, the coefficient of the first term of inequality (44) is greater than 0, that is,

$$1 - s - \frac{Gs}{P} > 0.$$

It can be known from the definition of the energy functional shown in equation (20) that E(t)≥0 Thus, Inequality (44) may be further transformed into the following form:

$$\frac{Gs}{P} [ E ( t ) + \frac{1}{G} W ( t ) ] + G [ \dot{E} ( t ) + \frac{1}{G} \dot{W} ( t ) ] ⩽ 0 \qquad ( 45 )$$

The Lyapunov function is defined, and is substituted into inequality (45), obtaining:

$${V}_{L} ( t ) ⩽ {a}_{0} {e}^{- \frac{s}{P} t} \qquad ( 46 )$$

where a₀=V_{L}(0). By means of inequality (24), it is easy to obtain that the Lyapunov function V_{L}(t) satisfies:

$${V}_{L} ( t ) = E ( t ) + \frac{1}{G} W ( t ) ⩾ ( 1 - \frac{1}{G} \frac{{m}_{1}}{{λ}_{0}} ) E ( t ) \qquad ( 47 )$$

Taking note of

$$G > max \{ \frac{{m}_{1}}{{λ}_{0}} , \frac{3}{2} {λ}_{{MC}^{- 1}}^{max} \} , 0 < 1 - \frac{1}{G} \frac{{m}_{1}}{{λ}_{0}} < 1$$

can be obtained. It is easy to obtain E(t)≥0 from the definitions of the energy functional and disturbance functional shown in equation (20). Thus, it is easy to obtain that inequality (47) satisfies the following relation:

$${V}_{L} ( t ) ⩾ ( 1 - \frac{1}{G} \frac{{m}_{1}}{{λ}_{0}} ) E ( t ) ⩾ 0 \qquad ( 48 )$$

In combination with inequalities (46) and (48), it is easy to obtain an exponential stability judgment condition under the framework of the Lyapunov stability theory:

$$0 ⩽ ( 1 - \frac{1}{G} \frac{{m}_{1}}{{λ}_{0}} ) E ( t ) ⩽ {V}_{L} ( t ) ⩽ {a}_{0} {e}^{- \frac{s}{P} t} \qquad ( 49 )$$

It can be obtained from the above inequality that the energy E(t) of the system in equation (14) satisfies the following relation

$$0 ⩽ E ( t ) ⩽ {b}_{0} {e}^{- \frac{s}{P} t} \qquad ( 50 )$$

where

$${b}_{0} = \frac{{a}_{0}}{1 - \frac{1}{G} \frac{{m}_{1}}{{λ}_{0}}} .$$

The above inequality (50) is an exponential stability judgment condition of the vibration energy E(t) of the system shown in equation (14) under the Lyapunov stability theory.

The Galerkin method indicates that for equation (5), an accurate solution may be obtained by adding approximation terms and appropriate eigenfunctions. Then, the vibration energy E(t) of the system shown in equation (14) is equal to the vibration energy of the original system shown in equation (4), so the vibration energy also satisfies the exponential stability judgment condition (50), that is, the original system shown in equation (4) may be considered to be exponentially stable.

Step 5: simulation verification

In this step, the conveying fluid pipe-NES system shown in FIG. 1 is taken as an example to verify the theoretical results of step 4. The vibration control effect of the nonlinear energy sink is illustrated by comparing the displacement response of the conveying fluid pipe when there is a nonlinear energy sink and the displacement response of the conveying fluid pipe when there is no nonlinear energy sink. Based on equation (4), the parameters of the conveying fluid pipe-NES system shown in FIG. 1 are set as follows: α=0.001, β=0.8, ε=0.1, σ=0.1, d=0.5, k=8000, and that the two ends of the conveying fluid pipe are simply supported indicates that the boundary condition thereof is as follows:

[symbol]

(0,t)= [symbol] (0,t)= [symbol] (1,t)= [symbol] (1,t)=0

In the case where different dimensionless flow velocities v are simulated, the energy flow function E(t), Lyapunov function V_{L}(t) and displacement response [symbol] (x,t) of the conveying fluid pipe of the conveying fluid pipe-NES system are used to verify the theoretical results of step 4 and describe the vibration control effect of the nonlinear energy sink.

However, because the system shown in equation (4) is a high-order partial differential dynamic system, the analytical solution of the transient dynamics thereof is very difficult to acquire and can only be acquired by means of the numerical method approximately. In order to acquire a high-accuracy approximate solution, the displacement function [symbol] (x,t) of the conveying fluid pipe must be truncated by at least two-order approximate terms in the Galerkin process of the system shown in equation (4). In order to obtain a better numerical convergence and reduce the difficulty in the simulation process and time used in the simulation process, it is selected and determined that n=2. To activate vibration, the initial conditions of the system are set as follows:

\dot{q}₁(0)=X,q₁(0)=q₂(0)=q₂(0)=0, [symbol] (0)= [symbol] (0)=0,

where X represents a constant.

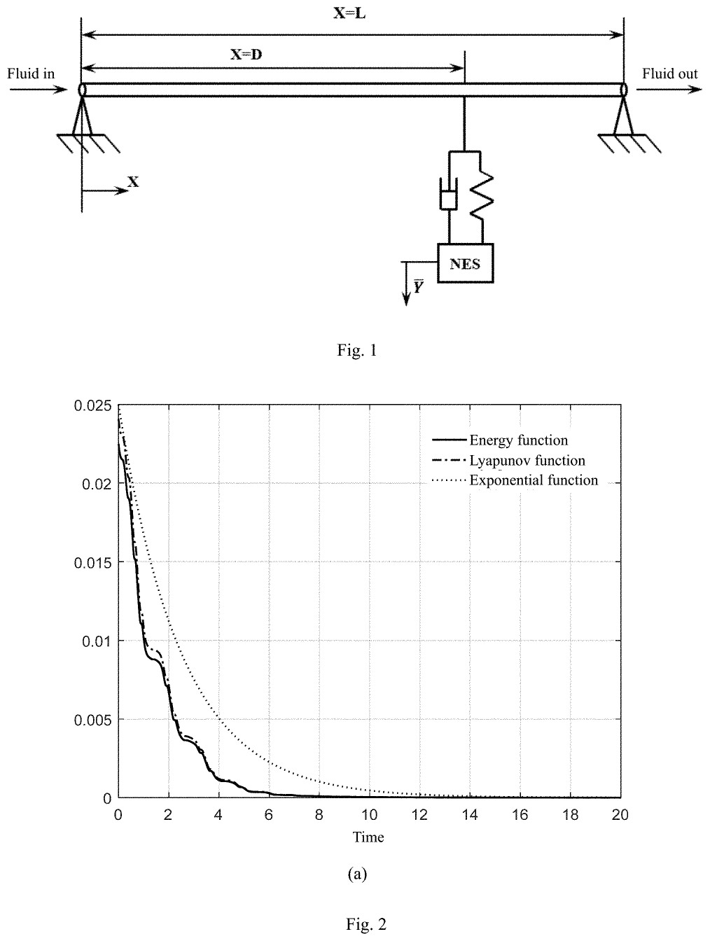

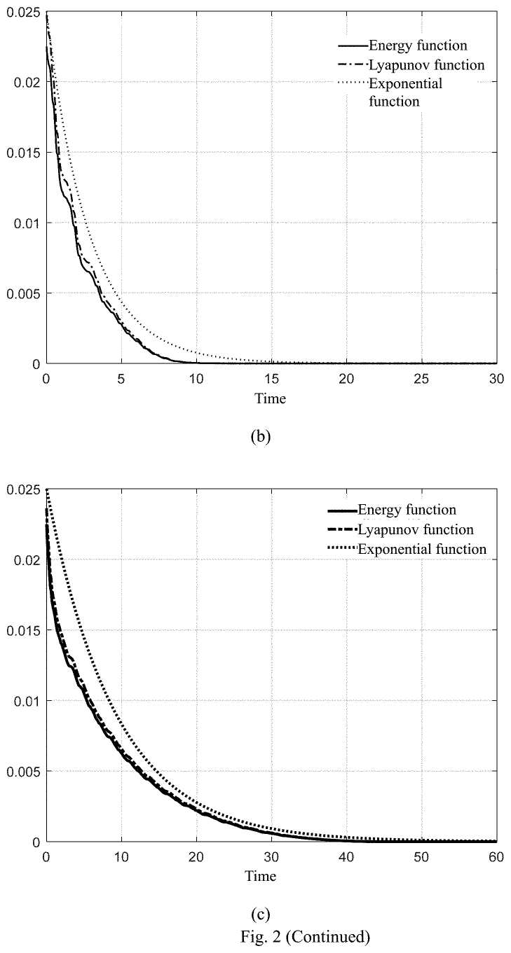

(a) in FIG. 2 shows simulation results of an energy function E(t) and a Lyapunov function V_{L}(t) of a conveying fluid pipe-NES system in the case where flow velocity v=1.0 and simulation excitation X=0.3, where the energy function E(t) in the figure is represented by full line, and the Lyapunov function V_{L}(t) is represented by chain line. According to the above results, it is easy to confirm an exponential function 0.025e^{-0.4t}, to make inequality (49) hold when v=1.0 (the relation among the dotted line, chain line and full line shown in (a) of FIG. 2). (b) in FIG. 2 shows simulation results of an energy function E(t) and a Lyapunov function V_{L}(t) in the case where the dimensionless flow velocity v=2.0, so it is easy to determine an exponential function 0.025e^{-0.35t}, to make an inequality 0≤E(t)≤V_{L}(t)≤0.025e^{-0.35t} hold (the relation among the dotted line, chain line and full line shown in (b) of FIG. 2), that is, make inequality (49) hold. When the dimensionless flow velocity v=3.0, the simulation results are as shown in (c) of FIG. 2. According to the relation among the dotted line, chain line and full line shown in (c) of FIG. 2, an exponential function 0.025e^{-0.11t} can be determined, so that the energy function E(t) and Lyapunov function V_{L}(t) satisfy the relation shown in equation (49). The above results verify the results given in step 4, that is, the system shown in equation (14) is exponentially stable. Further considering the approximation characteristics of the Galerkin method, it can be inferred that the original system shown in equation (4) is also exponentially stable. Thus, the effectiveness and the feasibility of the global stability analysis method designed by the present invention are further verified.

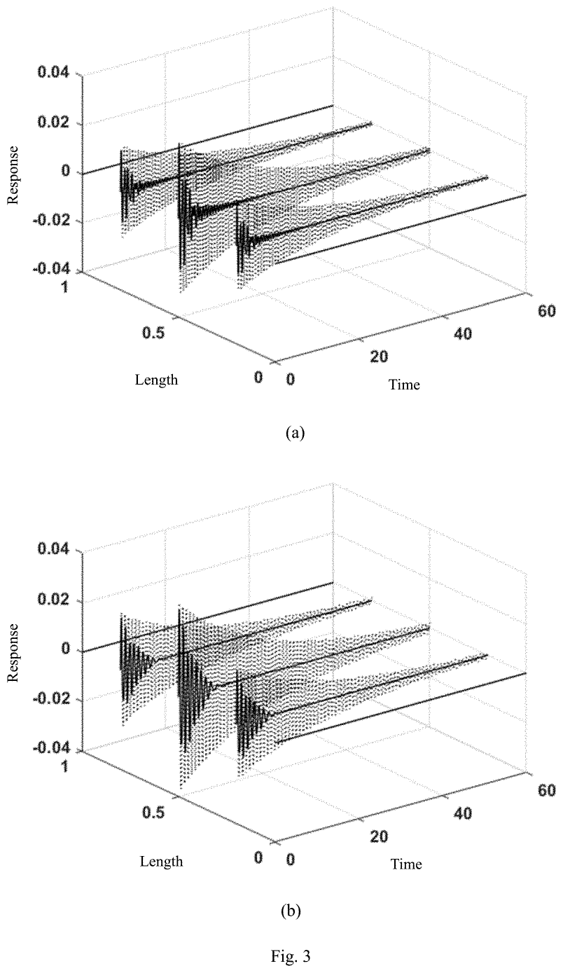

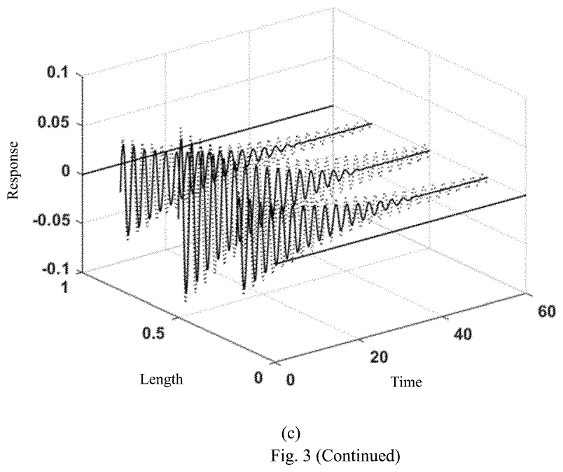

In order to further illustrate the vibration control effect of the nonlinear energy sink and the influence on the conveying fluid pipe after introduction, the displacement responses of the conveying fluid pipe under different conditions are simulated and analyzed, and the results are shown in FIG. 3. (a)-(c) in FIG. 3 respectively show displacement responses at three sections x=0.2, 0.5, 0.8 (corresponding to the length axis in the figure) of the conveying fluid pipe at different dimensionless flow velocities (corresponding to v=1.0, 2.0, 3.0 in sequence) when the simulation excitation X=0.3, that is, [symbol] (0.2,t), [symbol] (0.5,t), [symbol] (0.8,t). The dotted line represents the displacement response of each section of the conveying fluid pipe when there is no control, and the full line represents the displacement response of the conveying fluid pipe when nonlinear energy sink is used as a vibration controller. By comparing the changes of the full line and the dotted line in FIG. 3, it can be easily seen that the nonlinear energy sink can well suppress the vibration of the conveying fluid pipe, so that the displacement response thereof can be quickly reduced to a small range.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention. The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A method for analyzing global stability of a conveying fluid pipe-nonlinear energy sink system, comprising the following steps: transforming a model of the conveying fluid pipe-nonlinear energy sink system into a quadratic model containing a gradient term by establishing a potential function, and constructing an energy functional and a disturbance functional of the conveying fluid pipe-nonlinear energy sink system based on this model, and then obtaining a global stability judgment condition of the conveying fluid pipe-nonlinear energy sink system under the framework of the Lyapunov stability theory by means of the energy disturbance technology and functional analysis; the method comprises the following specific steps:
step 1: modeling and preprocessing of conveying fluid pipe-nonlinear energy sink system
the conveying fluid pipe is installed in a mode that both ends thereof are simply supported, and the nonlinear energy sink is connected with a conveying fluid pipe; without consideration of gravity, internal damping, external tension and pressurization effects, a mathematical model of the conveying fluid pipe-nonlinear energy sink is as follows:
$$EI \frac{{\partial }^{4} Y ( X , T )}{\partial {X}^{4}} + λ EI \frac{{\partial }^{5} Y ( X , T )}{\partial {X}^{4} \partial T} + {M}_{f} {V}_{2} \frac{{\partial }^{2} Y ( X , T )}{\partial {X}^{3}} + {M}_{f} V \frac{{\partial }^{2} Y ( X , T )}{\partial {X}^{2} \partial T} + ( {M}_{f} + {m}_{p} ) \frac{{\partial }^{2} Y ( X , T )}{\partial {T}^{2}} + \{ {K [ Y ( D , T ) - \overline{Y} ( T ) ]}^{3} + C [ \frac{\partial Y ( D , T )}{\partial T} - \frac{d \overline{Y} ( T )}{dT} ] \} δ ( X - D ) = 0 \\ {m}_{NES} \frac{{d}^{2} Y ( T )}{{dT}^{2}} + {K [ \overline{Y} ( T ) - T ( D , T ) ]}^{3} + C [ \frac{d \overline{Y} ( T )}{dT} - \frac{\partial Y ( D , T )}{\partial T} ] = 0 \qquad ( 1 )$$
where Y(X,T) represents a transverse displacement function of the conveying fluid pipe; EI represents a bending stiffness of the conveying fluid pipe; λ represents a viscoelastic coefficient of the conveying fluid pipe; M_{f} represents a mass of fluid in the conveying fluid pipe; mₚ represents a mass of the conveying fluid pipe itself; V represents a flow velocity of fluid in the conveying fluid pipe; T represents a time variable; Y̅(T) represents a displacement function of the nonlinear energy sink; m_{NES} represents a structure mass of the nonlinear energy sink; K represents a nonlinear stiffness of the nonlinear energy sink; C represents damping of the nonlinear energy sink; D represents an installation location of the nonlinear energy sink; and δ(X−D) represents a Dirac δ function;
the following non-dimensional quantities are performed on the parameters of the mathematical model of the conveying fluid pipe-nonlinear energy sink system:
$$y = \frac{Y}{L} , x = \frac{X}{L} , \overline{y} = \frac{\overline{Y}}{L} , d = \frac{D}{L} , k = \frac{{KL}^{6}}{EI} , v = VL \sqrt{\frac{{M}_{f}}{EI}} , t = \frac{T}{{L}^{2}} \sqrt{\frac{EI}{{M}_{f} + {m}_{p}}} \\ α = \frac{λ}{{L}^{2}} \sqrt{\frac{EI}{{M}_{f} + {m}_{p}}} mβ = \frac{{M}_{f}}{{M}_{f} + {m}_{p}} , ɛ \frac{{m}_{NES}}{{M}_{f} + {m}_{p}} , σ = \frac{{CL}^{2}}{\sqrt{EI ( {M}_{f} + {m}_{p} )}} \qquad ( 2 )$$
in equation (2), L represents a length of the conveying fluid pipe, x represents a dimensionless form of a length independent variable X of the conveying fluid pipe, [symbol] represents a dimensionless form of a longitudinal displacement Y(X,T) of the conveying fluid pipe, [symbol] represents a dimensionless form of a longitudinal displacement Y̅(T) of the nonlinear energy sink, d represents a dimensionless installation location of the nonlinear energy sink, k represents a dimensionless nonlinear stiffness of the nonlinear energy sink, v represents a dimensionless flow velocity of the fluid in the conveying fluid pipe, t represents a dimensionless time variable, α represents a dimensionless viscoelastic coefficient of the conveying fluid pipe, β represents a ratio of the mass of fluid in the conveying fluid pipe to the sum of the mass of the conveying fluid pipe and the mass of the fluid, ε represents a ratio of the structure mass of the nonlinear energy sink to the sum of the mass of the conveying fluid pipe itself and the mass of fluid in the conveying fluid pipe, and σ represents dimensionless damping of the nonlinear energy sink;
equation (2) is substituted into equation set (1), obtaining a dimensionless mathematical model of the conveying fluid pipe-nonlinear energy sink system:
$$\frac{{\partial }^{4} y ( x , t )}{\partial {x}^{4}} + α \frac{{\partial }^{5} y ( x , t )}{\partial {x}^{4} \partial t} + {v}^{2} \frac{{\partial }^{2} y ( x , t )}{\partial {x}^{2}} + 2 \sqrt{β v} \frac{{\partial }^{2} y ( x , t )}{\partial x \partial t} + \frac{{\partial }^{2} y ( x , t )}{\partial {x}^{2}} + {\{ k [ y ( d , t ) - \overline{y} ( t ) \} ]}^{3} + σ [ \frac{\partial y ( d , t )}{\partial t} - \frac{d \overline{y} ( t )}{dt} ] \} \partial ( x - d ) = 0 \\ ɛ \frac{{d}^{2} \overline{y} ( t )}{{dt}^{2}} + {k [ \overline{y} ( t ) - y ( d , t ) ]}^{3} + σ \frac{d \overline{y} ( t )}{dt} - \frac{\partial y ( d , t )}{\partial t} = 0 \qquad ( 3 )$$
step 2: model discretization
the standard Galerkin of the displacement function of the conveying fluid pipe-nonlinear energy sink system is:
$$y ( x , t ) = {\sum }_{r = 1}^{n} {ϕ}_{r} ( x ) {q}_{r} ( t ) \qquad ( 4 )$$
where ϕᵣ(x) represents the r^{th} eigenfunction when the conveying fluid pipe is in undamped free vibration; qᵣ(t) represents generalized coordinates of a discrete system; and n represents the number of Galerkin discrete terms;
equation (4) is substituted into equation (3), obtaining a second-order nonlinear ordinal differential equation (ODE) form shown in equation (5):
M\ddot{Z}+CŻ+KZ+FN(t)=0 (5)
where
$$Z = [ \frac{q}{y} ] ϵ {R}^{n + 1} , M = [ \begin{matrix}{M}_{0} & 0 \\ 0 & ɛ\end{matrix} ] , C = [ \begin{matrix}{C}_{0} + \tilde{C} & {\overline{C}}^{T} \\ \overline{C} & σ\end{matrix} ] , K = [ \begin{matrix}{K}_{0} & 0 \\ 0 & 0\end{matrix} ] \\ F = [ \begin{matrix}- k {ϕ}_{rd} \\ k\end{matrix} ] , N ( t ) = {( y - {ϕ}_{rd}^{T} q )}^{3} , {M}_{0} = {δ}_{r} , {C}_{0} = {αλ}_{r}^{4} {δ}_{r} + 2 \sqrt{β} {vb}_{r} \\ {K}_{0} = {λ}_{r}^{4} {δ}_{r} + {v}^{2} {c}_{r} , \tilde{C} = {σϕ}_{rd} {ϕ}_{rd}^{T} , \overline{C} = {ϕ}_{rd}^{T} \qquad ( 6 )$$
in equation (6), Rⁿ⁺¹, represents a n+1-dimensional space; λᵣ=rπ, r=1, . . . , n; ϕᵣ and ϕ_{rd} represent vectors composed of eigenfunctions in equation (4); q represents a vector composed of generalized coordinates in equation (4); and δᵣ, bᵣ and cᵣ represent Kronecker products of ϕᵣ and ϕᵣ, ϕᵣ and ϕᵣ′, and ϕᵣ and ϕᵣ″ respectively;
step 3: quadratic form change of model
based on equation (5), a potential function Φ(Z) of the conveying fluid pipe-nonlinear energy sink system is established, and Φ(Z) is a convex function:
$$Φ ( Z ) = \frac{1}{2} 〈 KZ , Z 〉 + \frac{k}{4} {( {ϕ}_{rd}^{T} q - \overline{y} )}^{4} \qquad ( 7 )$$
where [symbol] KZ,Z [symbol] represents an Euclidean inner product of vectors KZ and Z; equation (5) is transformed into:
M\ddot{Z}+CŻ+∇Φ(Z)=0 (8)
where ∇Φ(Z) represents a gradient of the convex function Φ(Z);
step 4: global stability analysis
based on equation (8), an energy functional E(t) and a disturbance functional W(t) of the conveying fluid pipe-nonlinear energy sink system are defined as follows:
E(t)=½ [symbol] MŻ,Ż [symbol] +Φ(Z) (9)
W(t)= [symbol] MŻ,Z [symbol] +½ [symbol] CZ,Z [symbol] (10)
based on the above energy functional and disturbance functional, a Lyapunov function V_{L}(t) is defined as follows:
$${V}_{L} ( t ) = E ( t ) + \frac{1}{G} W ( t ) \qquad ( 11 )$$
where G represents a coefficient of influence of the disturbance functional on the Lyapunov function, and
$$G > max \{ \frac{{m}_{1}}{{λ}_{1}} , \frac{3}{2} {λ}_{{MC}^{- 1}}^{max} \} ,$$
m₁ represents a maximum eigenvalue of a matrix M, λ₀ represents a minimum eigenvalue of a matrix C, and λ_{MC}_{^{−1}}^{max} represents a maximum eigenvalue of the product of the matrix M and an inverse matrix C⁻¹ of the matrix C;
further, by means of functional analysis, it is obtained that the Lyapunov function V_{L}(t) satisfies the following exponential stability judgment condition:
$$0 ⩽ ( 1 - \frac{1}{G} \frac{{m}_{1}}{{λ}_{0}} ) E ( t ) ⩽ {V}_{L} ( t ) ⩽ {a}_{0} {e}^{- \frac{s}{P} t} \qquad ( 12 )$$
where a₀=V_{L}(0), s and P are parameters greater than 0;
because
$$G > max \{ \frac{{m}_{1}}{{λ}_{0}} , \frac{3}{2} {λ}_{{MC}^{- 1}}^{max} \} , 0 < 1 - \frac{1}{G} \frac{{m}_{1}}{{λ}_{0}} < 1 ,$$
in combination with inequality (12), it is obtained that the energy functional E(t) satisfies the following relation:
$$0 ⩽ E ( t ) ⩽ {b}_{0} {e}^{- \frac{s}{P} t} \qquad ( 13 )$$
where
$${b}_{0} = \frac{{a}_{0}}{1 - \frac{1}{G} \frac{{m}_{1}}{{λ}_{0}}} ;$$
thus, it is obtained that inequality (13) is an exponential stability judgment condition of E(t);
in combination with inequality (13) and equations (5) and (4), it is obtained that the global stability of the conveying fluid pipe-nonlinear energy sink system shown in equation (3) is exponential stability.
